(19) United States
(12) Patent Application Publication
(10) Pub. No.: US 2004/0020100 A1
(43) Pub. Date: Feb. 5, 2004

(54) Apparatus for a wireless animal trap detection system

(76) Inventors: Denis Michael O'Brien, Austin, TX (US); Stephen Craig Rodriguez, Cedar Park, TX (US)

Correspondence Address: FULBRIGHT & JAWORSKI L.L.P., 600 CONGRESS AVE., SUITE 2400, AUSTIN, TX, 78701, US

(21) Appl. No.: 10/601,931

(22) Filed: Jun. 23, 2003

Related U.S. Application Data
(60) Provisional application No. 60/401,117, filed on Aug. 5, 2002.

(51) Int. Cl. A01M 1/00

(52) U.S. Cl. 43/1

(57) ABSTRACT

Systems are described for a wireless animal trap detection system. An apparatus includes an animal trap, a wireless radio frequency (RF) transmitter coupled to the animal trap wherein the wireless RF transmitter transmits a series of signals at substantially random intervals upon activation of the animal trap, and a receiver configured to receive the series of signals from the wireless RF transmitter.

### CROSS-REFERENCE(S) TO RELATED APPLICATION(S)

This application is related to, and claims a benefit of priority from, copending U.S. Ser. No. 60/401,117, filed Aug. 5, 2002, the entire contents of which are hereby expressly incorporated by reference for all purposes. This application also refers to Disclosure Document identification number 514,207, entitled Wireless Rodent Trap, which was received under the Disclosure Document Program at the U.S. Patent and Trademark Office on Jun. 24, 2002, the entire contents of which are hereby expressly incorporated by reference for all purposes.

### BACKGROUND OF THE INVENTION

1. Field of the Invention

The invention relates generally to the field of intrusion detection systems and the field of trap monitoring systems. More specifically, the invention relates to animal traps which utilize a wireless alert systems.

2. Discussion of the Related Art

Animal traps have been in use for years, and the majority of these devices use either a spring load or live trap device.

A problem with these conventional traps is that they are often placed in remote hard to monitor locations, for example, in an attic in a house, and there is no easy way of knowing when the trap is activated. Another problem with live traps is that the animal may be left in a very stressful environment when stuck in the trap for many hours or even days before the activated trap is discovered. One example of this stressful environment is when a live trap is placed in an attic that may reach temperatures in excess of 120° F. Another problem with the standard spring-loaded trap is that an animal is often left for extended periods of time to the point that they begin to decay attracting even more animals.

While these devices may be suitable for easy to monitor locations, they are not suitable for hard to monitor or remote locations. A problem with conventional spring loaded and live traps is that there is no way of knowing when they have been activated other than by viewing them.

Heretofore, animal trap activation detection systems have been able to provide basic on/off alert information trap to users with very limited and narrow applications. Examples of this include a spring-loaded trap that sounds a local audio signal when activated. While this attempts to solve the problem of alerting that a remote trap has been activated, it does not solve the fundamental problem if the trap is a considerable distance from the trap user. In addition the battery operated audio device has the disadvantage of causing the battery to run down. Another type of alert system uses sophisticated and expensive sensing techniques which alert the trap user once a trap activation has been detected. The expense and sophistication of the prior art may limit its use in a high volume low-tech field such as pest control. In general, these prior art approaches are too expensive, too sophisticated, and have a narrow scope of application.

No prior art has addressed specifically an alert system for the standard low cost spring-loaded animal trap or live trap in the manner herein described. It is with this present invention that a low cost battery operated RF sensor is being incorporated with such devices (live trap and spring loaded trap) along with a receiver which allows for the first time an affordable/manufacturable remote animal trap detection system.

Heretofore, the requirements for an animal trap that alerts remote users have not been fully met. What is needed is a solution that addresses these requirements.

### SUMMARY OF THE INVENTION

There is a need for the following embodiments. Of course, the invention is not limited to these embodiments.

According to an aspect of the invention, an apparatus comprises: an animal trap, a wireless radio frequency (RF) transmitter coupled to the animal trap wherein the wireless RF transmitter transmits a plurality of signals at substantially random intervals upon activation of the animal trap, and a receiver configured to receive the plurality of signals from the wireless RF transmitter.

According to another aspect of the invention, a wireless animal trap activation detection kit capable of being assembled in the field on a cage of a live animal trap is provided, the kit comprising the combination of: a wireless transmitter configured to be mounted on a live animal trap and to transmit a plurality of signals upon activation of the live animal trap, a mounting mechanism adapted to affix the wireless transmitter to the live animal trap, and a receiver locatable at a remote distance and configured to receive the plurality of signals from the wireless transmitter and to alert a user of activation of the live animal trap.

According to yet another aspect of the invention, a wireless animal trap detection kit capable of being assembled in the field to be electrically coupled to a spring-loaded rodent/animal trap is provided, the kit comprising the combination of: a wireless transmitter configured to be electrically coupled to a spring-loaded rodent/animal trap in a closed circuit such that activation of the spring-loaded rodent/animal trap opens the circuit and to transmit a plurality of signals upon activation of the spring-loaded rodent/animal trap, connector adapted to electrically couple the wireless transmitter to the spring-loaded rodent/animal trap, and a receiver locatable at a remote distance and configured to receive the plurality of signals from the wireless transmitter and to alert a user of activation of the spring-loaded rodent/animal trap.

These, and other, embodiments of the invention will be better appreciated and understood when considered in conjunction with the following description and the accompanying drawings. It should be understood, however, that the following description, while indicating various embodiments of the invention and numerous specific details thereof, is given by way of illustration and not of limitation. Many substitutions, modifications, additions and/or rearrangements may be made within the scope of the invention without departing from the spirit thereof, and the invention includes all such substitutions, modifications, additions and/or rearrangements.

### BRIEF DESCRIPTION OF THE DRAWINGS

The drawings accompanying and forming part of this specification are included to depict certain aspects of the invention. A clearer conception of the invention, and of the components and operation of systems provided with the invention, will become more readily apparent by referring to the exemplary, and therefore nonlimiting, embodiments illustrated in the drawings, wherein like reference numerals (if they occur in more than one view) designate the same elements. The invention may be better understood by reference to one or more of these drawings in combination with the description presented herein. It should be noted that the features illustrated in the drawings are not necessarily drawn to scale.

FIG. 1 is a diagram of an embodiment of the present invention.

FIGS. 2a and 2b are side views of a live animal trap fitted with a wireless transmitter in accordance with an embodiment of the present invention.

FIG. 3 is a wireless transmitter adapted to be used with a live animal trap, in accordance with an embodiment of the present invention.

FIG. 4 is a perspective view of a spring-loaded rodent/animal trap fitted with a RF wireless transmitter that is in accordance with an embodiment of the present invention.

FIG. 5 is a wireless transmitter adapted to be used with a spring-loaded rodent/animal trap, in accordance with an embodiment of the present invention.

FIG. 6 is a retrofit wireless transmitter/receiver kit, in accordance with an embodiment of the present invention.

FIG. 7 is a block diagram of a transmitter unit, in accordance with an aspect of an embodiment of the present invention.

FIG. 8 is a schematic of a transmitter unit, in accordance with an aspect of an embodiment of the present invention.

FIG. 9 is a block diagram of a receiver unit, in accordance with an aspect of an embodiment of the present invention.

FIG. 10 is a schematic of a receiver unit, in accordance with an aspect of an embodiment of the present invention.

### DETAILED DESCRIPTION

The invention and the various features and advantageous details thereof are explained more fully with reference to the nonlimiting embodiments that are illustrated in the accompanying drawings and detailed in the following description. Descriptions of well known starting materials, processing techniques, components and equipment are omitted so as not to unnecessarily obscure the invention in detail. It should be understood, however, that the detailed description and the specific examples, while indicating preferred embodiments of the invention, are given by way of illustration only and not by way of limitation. Various substitutions, modifications, additions and/or rearrangements within the spirit and/or scope of the underlying inventive concept will become apparent to those skilled in the art from this disclosure.

The present invention overcomes the above-noted shortcomings of the prior art by applying a simple and inexpensive alert concept to the application of a live animal trap as well as a spring loaded rodent/animal trap utilizing a RF transmitter and receiver.

The present invention provides an alert system, which may offer both a local alert for notifying an onsite property owner as well as a remote alert for notifying pest control, by providing an interface for an auto dialer. The present invention provides a complete system solution for pest control. Simplicity, ease of use, and cost savings are key features.

Significant pest control cost savings may be realized because normally the pest control company must physically check on the status of all traps. With the present invention, the pest control company may be notified by phone when their trap is activated, thereby eliminating costly daily trips to check on traps. In addition, the alert system provides a significant benefit to the homeowner since the system provides a local home alert. This may eliminate the need for the homeowner to enter potentially dangerous animal infested areas to check on the trap(s).

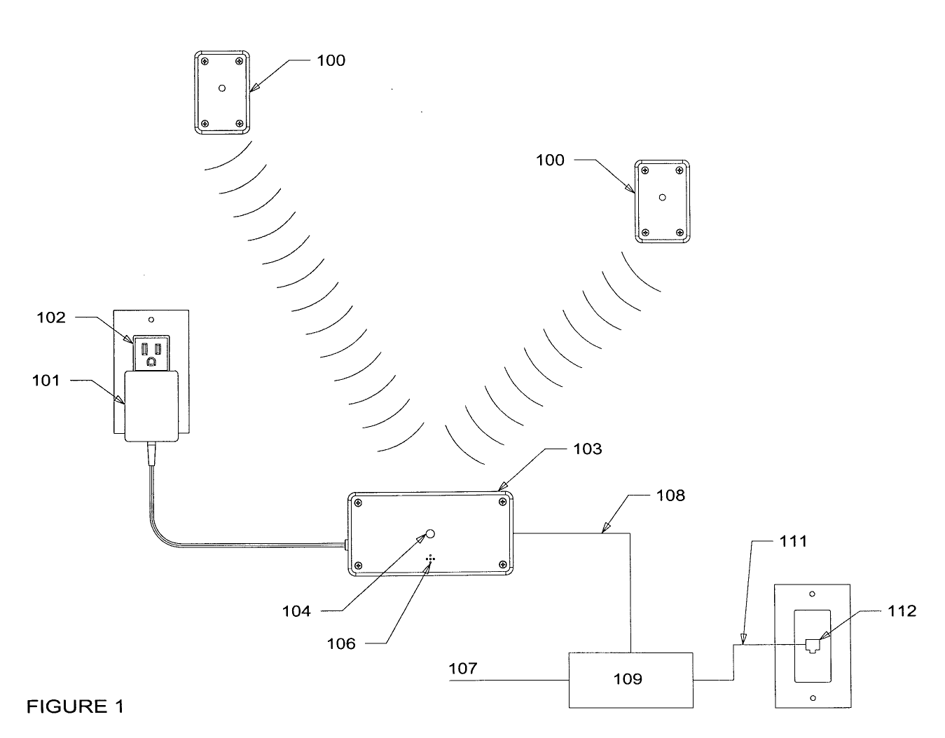

The present invention generally comprises one or more battery operated RF transmitters 100, as shown in FIG. 1, which may be mounted or attached to a pre-existing trap, and a receiver 103 capable of alerting through the use of visual and audible and telecommunication signaling methods, in accordance with an embodiment of the invention. The transmitter 100 sends an encoded signal to the receiver base unit 103. After a specified transmit duration, according to one embodiment of the invention, power may be removed from the transmitter 100, thereby saving substantial battery power and extending the transmitter life. In another embodiment of the invention, after a specified transmit duration, the transmitter 100 may be placed in a low power mode.

In operation, the receiver base unit 103 decodes the signal and then may activate audible (buzzer 106) and visual (LED 104) alarms as well as an auto dialer interface 108, all of which are powered by either a battery or external power, which may comprise an AC adapter 101 connected to an external power source 102. The transmitter 100 and receiver 103 may be used both indoors and outdoors.

In one embodiment of the present invention, once a valid signal is received and decoded by the receiver 103, the receiver base unit 103 will activate alarms 104, 106, 108 and continue to do so as long as power is applied. In other embodiments of the invention, power saving modes whereby an alarm is activated for specific periods of time are also contemplated. Provisions are also available to activate other RF remote devices such as RF activated auto dialers, audible alarms, long-range RF transmitters or indicators.

As shown in FIG. 1, a plurality of transmitters 100 may activate a single receiver 103. In other embodiments, a single transmitter 100 or a plurality of transmitters 100 may activate one or more receivers 103.

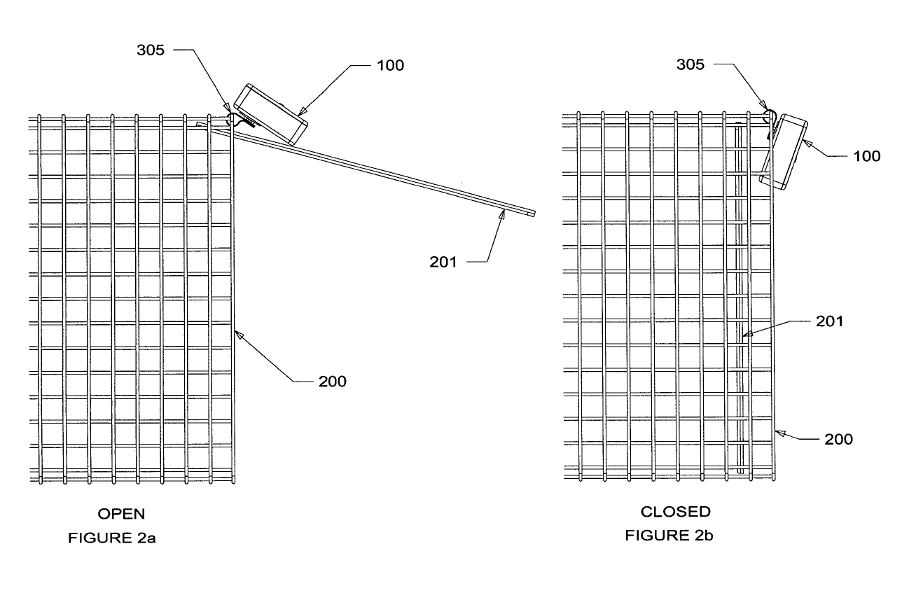

FIG. 2a is a transmitter 100 that is mounted onto a live animal trap 200. As shown, the transmitter 100 is attached by a suitable mechanism, for example, a clip 305 that attaches transmitter 100 to the trap door 201 of the animal trap 200. The live animal trap 200 may be any cage-like device with a spring loaded or gravity assisted door that has a trigger mechanism for door closure. The transmitter 100 may be mounted on any location on the trap 200 or nearby and upon sensing trap activation, it transmits a signal to the receiver 103, as shown in FIG. 1. Transmitter 100 may be attached to the cage doorframe, as shown in FIGS. 2a and 2b, or an alternate location, such as directly to the trap door 201. The advantage of mounting the transmitter to the doorframe includes less shock and vibration to the unit. This is illustrated in FIG. 2a where the trap 200 has not been activated, and FIG. 2b where the trap 200 has been activated. In FIG. 2b, transmitter 100 swings free from the cage door frame d does not contact door 201. In this manner, transmitter 100 is somewhat isolated from the shock and vibration of the activating of trap door 201, and is somewhat isolated from shocks and vibrations due to movement of an animal trapped within cage 200.

The transmitter 100 may be activated by various sensors (i.e. disturbance switch, tilt switch, proximity sensor, magnetic switch etc.) According to an embodiment of the invention, the transmitter sensor may include a tilt switch mounted in the transmitter 100 such that when the transmitter 100 is in a horizontal position, the tilt switch turns off power to the transmitter 100. When the door 201 closes, the transmitter 100 is in a substantially vertical position, and the tilt switch applies power to transmitter 100.

In one embodiment, a disturbance switch may be used as the transmitter sensor and may act as a vibration sensor to sense trap vibrations caused by animal movement in the live animal trap 200. When the sensor is a proximity sensor, transmitter 100 may be mounted on the cage and hardwired to the proximity sensor so that the transmitter 100 and the proximity sensor located on the trap door 201 are aligned when the trap door 201 is closed.

The transmitter 100 may be permanently mounted or temporarily mounted to trap 200 using a clip 305 for quick connect disconnect of the device and ease of installation; no costly trap modifications are required. The sensor may also be attached to a pre-existing trap using a hook and loop fastener, clamps, or cable ties, to hold the components together without the use of mounting screws.

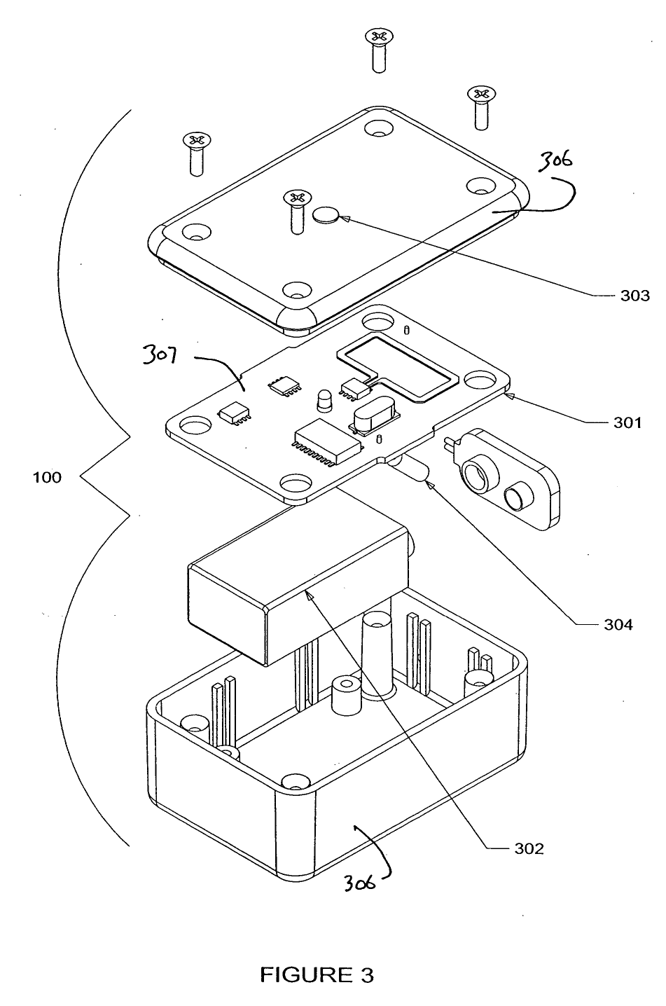

As shown in FIG. 3, the transmitter 100, according to an aspect of an embodiment of the invention, includes a tilt switch 304 that is coupled to transmit circuitry 301. The transmit circuitry 301 is powered by an electrical source, such as a battery 302. The transmit circuitry 301 produces and emits signals that indicate if the live animal trap 200 has been sprung and also causes a LED 303 to light once the live animal trap 200 has been spring. The tilt switch 304 may be, but is not limited to, a mercury switch, changeover switch, or ball contact switch. The transmit circuitry 301, tilt switch 304, and battery 302 may be enclosed within an outer housing 306. The transmit circuitry 301 may be mounted on a printed circuit board (PCB) 307. The PCB 307 may be mounted in the transmitter or without screws; the PCB 307 being held in place by the outer housing 307 pressing again a rubber bumper (not shown) that is coupled to the PCB 307.

Upon reliable detection of trap activation, the transmitter 100 transmits a unique code to the receiver unit, which decodes the message and turns on an alert indicator (LED, Buzzer etc), which notifies the homeowner that trap has been activated. The receiver unit may also be configured to activate an auto dialer 109 to notify a remote party of the trap activation.

Once activated, the transmitter will continue to transmit at substantially random intervals or any time trap vibrations due to animal movement in the trap are sensed, if a disturbance switch is used. This adds an extra level of system robustness which ensures that multiple transmit signals are sent to the receiver to increase the odds that the animal is rescued in a timely manner.

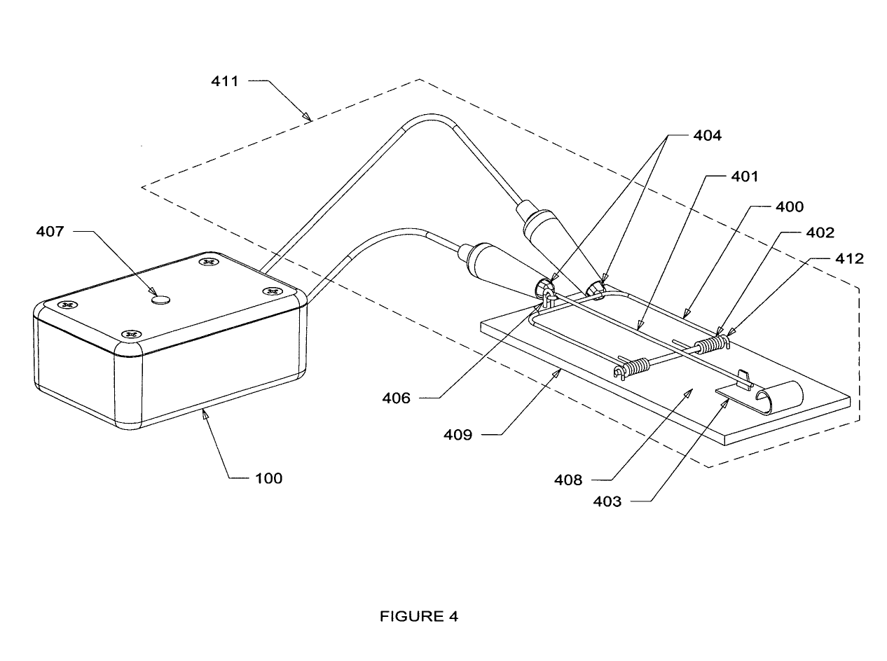

FIG. 4 shows an aspect of an embodiment of the invention as implemented with a spring-loaded rodent/animal trap. This embodiment comprises a standard spring-loaded trap 411 comprising of a base member 409, a trapping mechanism 408 mounted to the base member 409. A trapping mechanism 408 comprising a jaw member 400, at least one biasing member 402 to provide a torsional force on the jaw member 400 and a jaw retaining member 401 to hold the jaw member 400 under the torsional force in a cocked position and a trigger member 403 connected to the jaw retaining member 401. When triggered by the application of a triggering force to the trigger member 403, the trigger member 403 releases the jaw-retaining member 401 such that the jaw member 400 is driven by torsional force from its cocked position to trap the animal.

In addition, the mechanical portion of the trap is connected via electrical contacts, for example a connector method such as alligator clips 404 or wires, to a transmitter 100, which may be mounted on or nearby the trap. The wireless transmitter 100 may be electrically attached to the trap at two points (i.e. attach to jaw member 400 and jaw retaining member 401). The contact points are used to monitor for a trap activated trigger event for the wireless transmitter. With the trap in the cocked position, electrical contacts are established to provide continuity (completing the circuit). When the trap has been activated, at least one connector (i.e. alligator clips 404) attach point is disconnected by the torsional force of the jaw member 400 which results in a no-continuity (open) condition. The connectors, such as alligator clips 406, may also be attached to two points on the spring-loaded trap 411 such that when the trap 411 is activated, the connectors 406 do not physically disconnect from the trap 411, but a no-continuity condition is still realized. Two connection sites which could be used for this purpose are the u-shaped nail 406 and point labeled 412 located on jaw member 400. An advantage of this method is less wear and tear on the contacts 404.

Upon activation of the trap, at least one lead is disconnected as a result of the trap activation. The spring loaded bar jaw member 400 is driven by torsional force from its cocked position to trap the animal. This torsional force disconnects one of the electrical contacts to the trap, thereby providing a no continuity condition, which activates the transmitter 100. While the transmitter activation electrical event is described here as an open condition, the electrical event may be other states, as well (i.e. a short-continuity, or tristate).

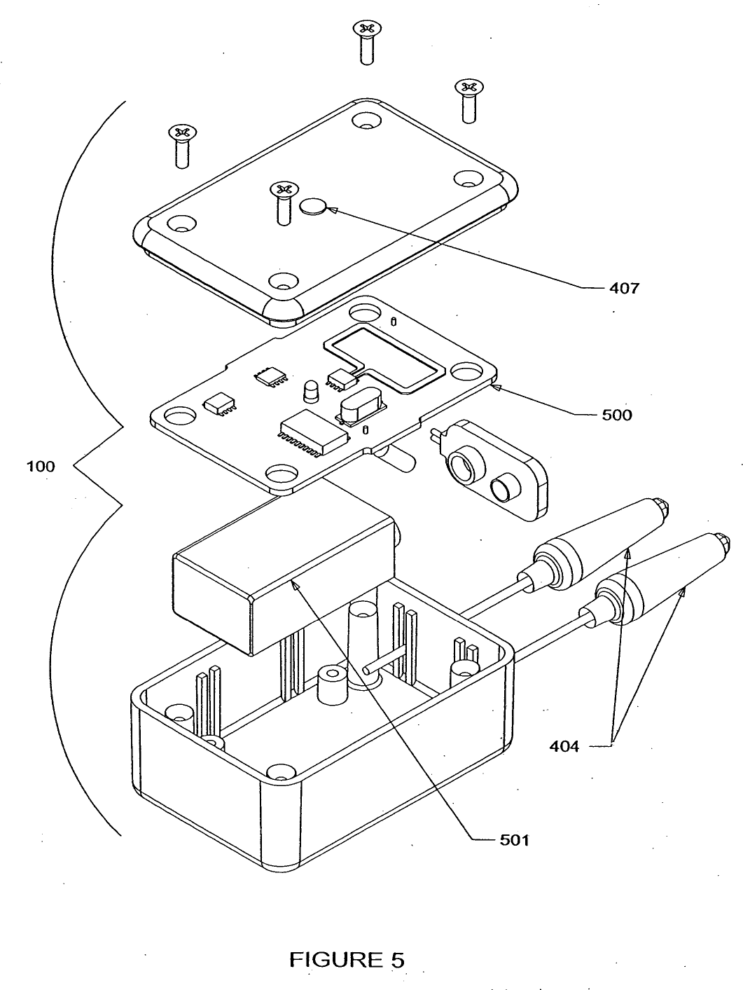

As shown in FIG. 5, the transmitter 100, according to an aspect of an embodiment of the invention, includes a mechanism for connecting the transmitter 100 to a spring loaded rodent/animal trap, such as alligator clamps 404 or wires, that are coupled to transmit circuitry 500. The transmit circuitry 500 is powered by an electrical source, such as a battery 501. The transmit circuitry 500 produces and emits signals that indicate if the spring loaded rodent/animal trap has been sprung and also causes a LED 407 to light once the spring loaded rodent/animal trap has been sprung.

According to one embodiment, the invention may also be included in a kit. The kit may include some, or all, of the components that compose the invention. The kit may be an in-the-field retrofit kit to improve existing animal traps. By augmenting an existing animal trap with the kit, properties of animal traps equipped with the transmitters and receivers described earlier may be realized.

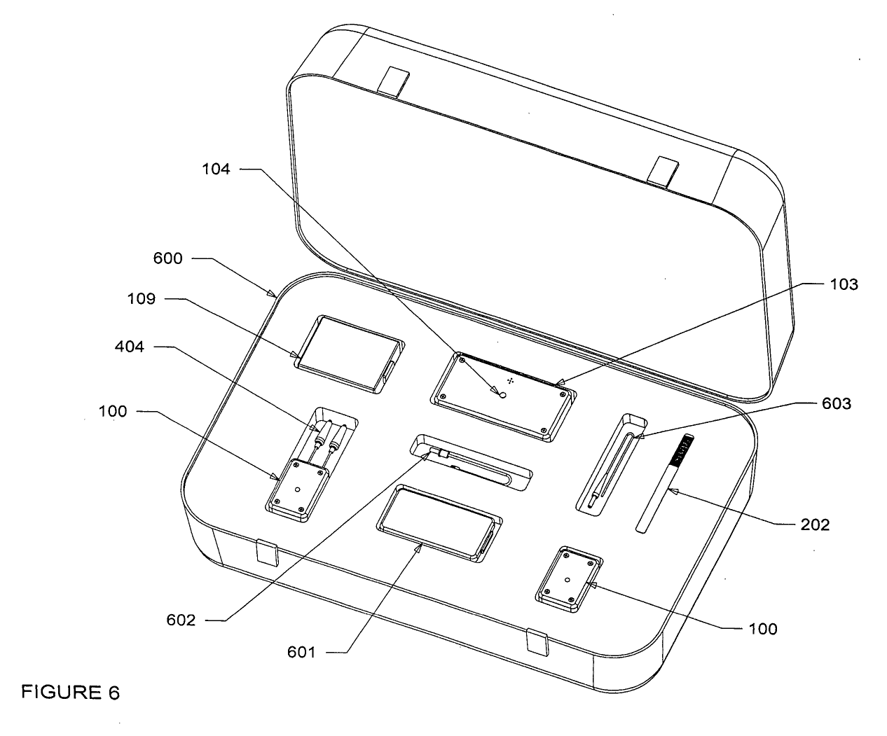

An example kit, in accordance with an embodiment of the invention is shown in FIG. 6. The kit 600 may contain a transmitter 100 which may be connected to a trap by alligator clips 404 or be mounted on the trap using a clip or a hook and loop fastener strap 202. Other methods of fitting the transmitter 100 to the pre-existing trap include using clips, clamps, or cable ties to hold the transmitter 100 to the trap or wires which produces an electric connection between the transmitter 100 and the trap. The cable ties may be used in conjunction with a cable tie mounting base.

The kit 600 may also include a receiver 103 and a battery pack 601 or other power supply connector, such as an AC adapter 101 for the receiver 103. The receiver 103 may have an LED 104 and an internal buzzer that indicates when a trap has been sprung. The receiver 103 may have one external power input, a connection for a battery pack, and connectors that provide for activation of standard auto dialers (i.e. FET, contact closure etc.) A connector 602 for the battery pack 601 and the receiver 103 may be included, as well as an antenna 603 for the receiver. An auto dialer 109 may be a part of the kit, as well. The third party (off the shelf) auto dialer 109 may be powered externally via its own ac to dc converter. The auto dialer 109 may be activated using the auto dialer's external terminal inputs. An acceptable auto dialer, such as the Radio Shack Security Auto Dialer, may be found at various electronics stores.

In use, the components of kit 600 are used to retrofit pre-existing animal traps in the field. In this manner, a business may make use of its exiting animal taps and need not purchase new traps. In addition, since the components of the kit of the present invention are easily attached to and removed from pre-existing traps, a user may choose to retrofit some, but not all of his or her exiting traps, and may easily change the kits from trap to trap, without modifying the preexisting traps.

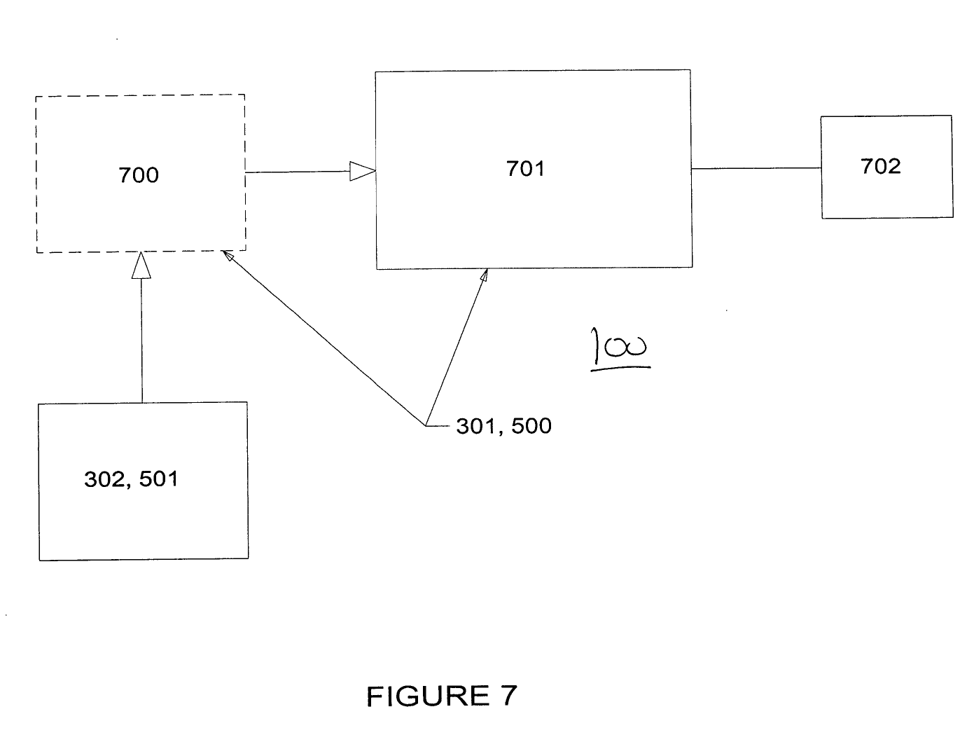

FIG. 7 is a block diagram of the transmitter 100. A battery pack 302, 501 or other electrical power source is coupled to the transmit circuitry 301, 500. The transmit circuitry 301, 500 may comprise a transmit activation circuit 700 and a transmission circuit 701, which may be coupled to an antenna 702. The transmit activation circuit 700 is coupled to the transmission circuit 701 and detects when the trap has been sprung. Once that occurs, the transmit activation circuit 700 send a signal to the transmission circuitry 701 which sends a signal through the antenna 702 to the receiver to alert an user as to the state of the trap. In accordance with one embodiment of the invention, if the trap has not sprung, the transmit circuit 701 may send an alternate signal to the receiver to establish that the trap has not sprung and that the transmitter 100 is still functioning properly.

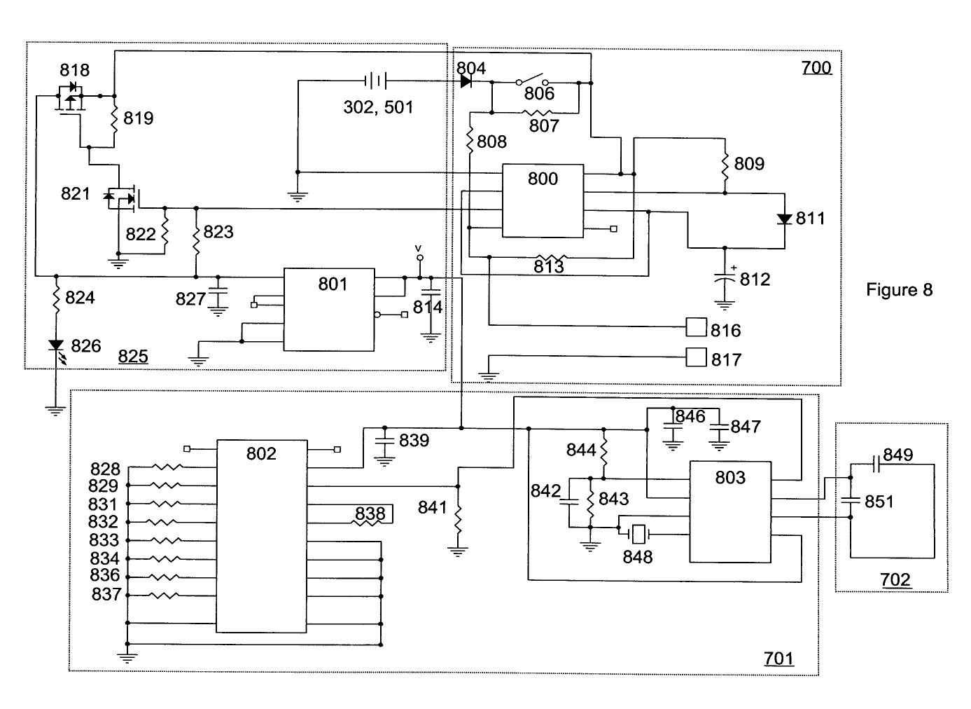

FIG. 8 is a circuit diagram of a transmitter 100, in accordance with an aspect of an embodiment of the invention. As shown in FIG. 8, transmit activation circuit 700 comprises a 555 timer 800 coupled to resistor 809, diode 811, and capacitor 812. The 555 timer is also coupled to a power source 302, 501 and diode 804. In a transmitter for a live animal trap, such as the one shown in FIG. 3, the tilt switch 806 is coupled to the 555 timer, as is resistor 813. Resistors 807, 808 and wire connections 816, 817 are not included in the circuit for the live animal trap transmitter. For a spring-loaded rodent/animal trap transmitter 100, such as the one shown in FIG. 5, switch 806 and resistor 813 are not included in the circuit, and resistors 807, 808 are inserted. In addition, wire connection 817 is coupled to ground and wire connection 816 is coupled to resistor 808 in series. The wire connections 816, 817 connect the transmitter activation circuit 700 to the alligator clamps 406 shown in FIG. 4.

The transmit activation circuit 700 is coupled to a voltage regulator circuit 825. The voltage regulator circuit 825 comprises a voltage regulator 801 that is coupled to capacitor 827, resistors 823, 824 and transistor 818. Transistor 818 is coupled to resistor 819, transistor 821, and either switch 806 in a live trap transmitter, or resistor 807 in a spring-loaded rodent/animal trap transmitter. Transistor 821 is coupled to resistors 822 and 823. The voltage regulator 801 is also coupled to a capacitor 814 and to the transmission circuit 701

Voltage regulator 801 and capacitor 814 are coupled to capacitor 839, resistor 844 and transmitter chip 803. Capacitor 839 is coupled to an encoder/processor chip 802, for example, a HT-12E encoder from Holtek (Freemont, Calif.) or a PIC16C73A from Microchip (Chandler, Ariz.), which is also coupled to resistors 828-838, and 841. Resistor 841 is also coupled to a transmitter chip 803, for example, a MICRF102 integrated circuit transmitter from Micrel (San Jose, Calif.). The transmitter chip 803 is coupled to capacitors 846, 847 in parallel, resistors 843-844 and capacitor 842, a transmitter crystal 848 and a loop antenna circuit 702. The loop antenna circuit 702 comprises capacitors 849 and 851.

For a transmission circuit 701 that is activated when switch 806 is closed to provide power to the circuit, such as a transmitter for a live animal trap, as described in FIGS. 2-3, activation of the animal trap provides power to the 555 timer 800; otherwise, the 555 timer 800 is not powered. The output of 555 timer 800 is the input to a voltage regulator 801. The output of the voltage regulator 801 powers the remainder of the transmitter circuit, including the encoder/processor chip 802 which generates the encoded signal that indicates an activated animal trap. The encoded signal may be user set using DIP switches, represented by the resistances 828-837, which adjust the input resistances to the encoder/processor chip 802. Other types of input may be provided means to the encoder/processor chip 802 to change the code. The encoded signal is then transmitted by a RF transmitter chip 803 and a loop antenna 702. The encoder/processor chip 802 used in the transmission circuit 201 may also be a microprocessor configured to perform functions similar to those described for the encoder/processor chip 802.

Upon detection of trap activation, an encoded signal is transmitted by transmitter 100. Then, another encoded pulse is sent at a substantially random time internal to ensure that the receiver has received the signal. This substantially random time interval may be in the range of from one to twenty minutes. This is repeated until the cage door is opened or the transmitter is deactivated. Signal transmission is indicated via the LED indicator 826 turning on for the length of the pulse duration.

The life of the battery 302, 511 may be increased by a combination of factors. The factors include requiring that the trap is activated before, the 555 based timer is used to provide power voltage to the transmit circuit for only a brief and adjustable time (for example, 1.5 seconds), and the retransmit rate is substantially random and takes place 2-4 times per hour, as dictated by the discharge rate of the capacitor 812 as described below.

For a spring-loaded rodent/animal trap, such as that shown in FIGS. 4 and 5, two wires or other electrical connecting mechanisms connected to the connectors 816, 817 control whether the timer 800 is held in reset or not. When the spring-loaded trap is set and not activated, power is always applied to the timer 800 and the timer 800 is in a reset state. When the trap has been activated, the timer 800 is taken out of the reset state, and it will send an output signal to power the voltage regulator 801 and thus the encoder/processor chip 802 at random intervals. All other functional aspects of the transmission circuit for a spring-loaded rodent/animal trap are identical to that of a live animal trap.

Typically, timers, including the 555 timer-based design of the exemplary embodiment, have been designed as periodic timers/transmitters. In contrast, the 555 timer-based transmitters described herein transmit at substantially random, nonperiodic and non-predetermined intervals. The benefit of this design includes being able to transmit at higher transmit power levels as described in FCC part 15.231 (class B radiated emissions tests) when compared to periodic transmitters. This translates to increased transmit distance for the present invention and provides a distinct competitive advantage.

This advantage may be achieved by removing the resistor that is normally placed between the threshold detect pin and the discharge pin in a 555 timer-based design. This resistor normally provides a discharge path for capacitor 812, the capacitor on the threshold detect pin, which would result in a periodic discharge time. By removing this resistor, the discharge rate of the capacitor 812 is now dictated by leakage properties of the capacitor, leakage paths of the circuit, and leakage current into the threshold detect pin, all of which are affected by temperature and humidity. This results in substantially random signal transmission intervals for this transmitter 100.

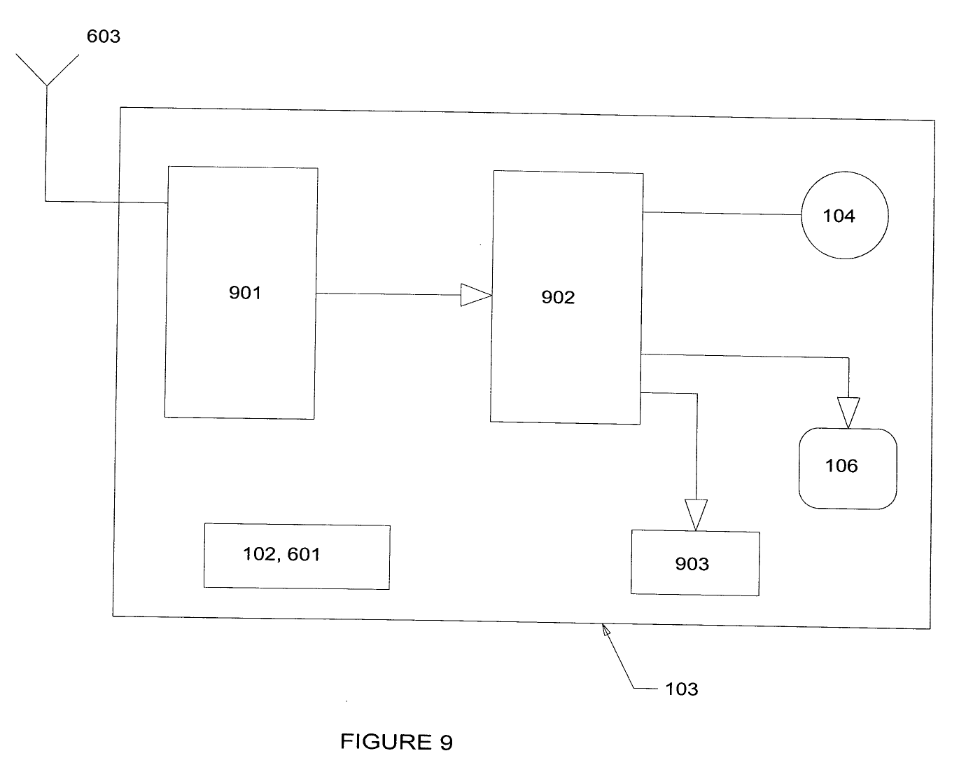

FIG. 9 is a block diagram of the receiver 103. The receiver may include an antenna 603, a signal receiver 901, a signal decoder/processor chip 902, an LED 104, a buzzer 106, and an auto dialer interface 903. The receiver may be powered by an external power source 102 such as AC/DC 102 power in conjunction with an AC adapter 101 or a battery pack 601.

The antenna 603 is coupled to the signal receiver 901, which receives an incoming signal. The signal receiver 901 transmits the received signal to the signal decoder/processor chip 902 which determines if a trap has been sprung. If a trap has been sprung, then the decoder/processor chip 902 sends signals to the LED 104, and buzzer 106 to alert the user. The decoder/processor chip 902 may also activate an auto dialer through the auto dialer interface 903 to call a preset telephone number to alert an exterminator or pest control personnel.

The receiver 103 may be powered by a standard wall unit AC to DC converter 101. The input voltage to the receiver may be 9V, 100 mA. The receiver 103 (once activated by the transmitter) will indicate an activated trap by flashing an LED 104 and/or audible sound such as a buzzer 106. In addition, the receiver 103 may activate an output 903 (i.e. a relay contact closure or FET open drain output), which can be used to activate a standard auto dialer. Once the receiver 103 is activated, the LED 104 and buzzer 106 may activate to alert the home occupant that the trap has been activated. Although the receiver 103 is shown in FIG. 1 to be externally powered, it may also be battery powered. When the receiver 103 is battery powered, the frequency of the audio/visual alarms may be adjusted to conserve power. The range of the unit, power supply and alert mechanism all may be modified to fit the user application.

The DC input connector of the receiver 103 may also double as an antenna input. This may provide a pathway for a 315 MHz signal to enter the receiver and extend its range by approximately 20 ft. A battery pack 601 may be used to power the receiver. This battery pack 601 allows for standalone battery operations or acts as a backup power source so that if DC power is removed, battery power would then take over. The battery pack 601 may be detachable for easy replacement.

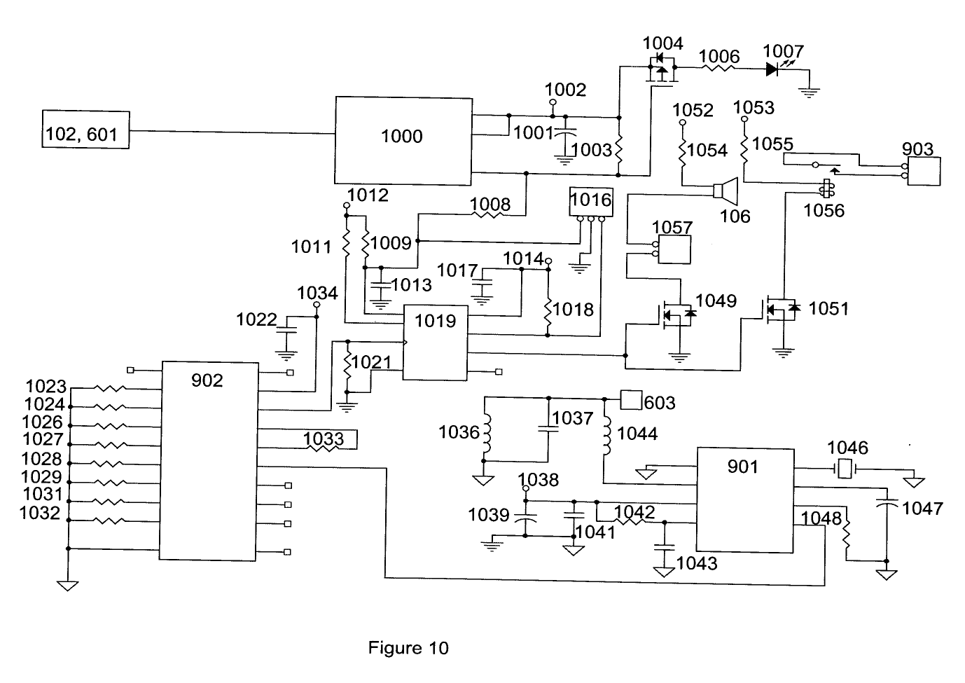

FIG. 10 is a circuit diagram of a receiver, in accordance with an aspect of an embodiment of the invention. An antenna connection 603 is coupled to an inductor 1044 which, in turn, is coupled to a receiver chip 901. Receiver chip 901, may be, for example, a MICRF007 available from Micrel. The antenna connection 603 may also be coupled to a bandpass filter, including an inductor 1036 and a capacitor 1037. The receiver chip 901 is also coupled to an input voltage 1038, a capacitor 1039 and capacitor 1041 in parallel, a resistor 1042 and a capacitor 1043 in parallel, a capacitor 1047 and resistor 1048 in series, and a receiver crystal 1046.

In addition, the receiver chip 901 is coupled to a decoder/processor chip 902 that is coupled to resistors 1023-1033. Decoder/processor chip 902 may be, for example, a HT-12D controller available from Holtek. The receiver chip 901 is also coupled to a voltage source 1034, a capacitor 1022, a resistor 1021 and a processor, such as a flip-flop 1019. The flip-flop 1019 is couple to a voltage source 1012, resistors 1009, 1011, capacitor 1013, resistor 1018, capacitor 1017, and voltage input 1014. Capacitor 1013 is also coupled to resistor 1008 that is also coupled to a voltage regulator 1000. The voltage regulator 1000 receives a power source from an A/C 102 or a battery 601, and is also coupled to a capacitor 1001, resistor 1003, a voltage output 1002 and transistor 1004. Transistor 1004 is also coupled to resistor 1006 and diode 1007.

The flip-flop 1019 is also coupled to transistors 1049, 1051. Transistor 1049 is coupled to an LED connector 1057, a buzzer 106, a resistor 1054 and a voltage source 1052. Transistor 1051 is coupled to a relay 1056, a resistor 1055, and a voltage source 1053. The relay 1056 is coupled to an auto dialer connector 903.

The receiver receives a signal from a transmitter via an antenna connected to the antenna connection 603 and the receiver chip 901. The signal is output from the receiver chip 901 to the decoder/processor chip 902 which identifies the code of the transmitter from which the signal was sent. The encoded signal to be recognized by the decoder/processor chip 902 may be user set using DIP switches, represented by the resistances 1023-1032, which adjust the input resistances to the decoder/processor chip 902. Other manual input methods may be used to set the code of decoder/processor chip 902. The received code matches the code set in decoder/processor ship 902, trap activation is detected and the output of the decoder/processor chip 902 is sent to a flip-flop 1019 whose output controls the buzzer 106, LED connection 1057, and the auto dialer interface 903. The voltage regulator 1000 controls the voltage input into the circuit. The decoder/processor chip 902 used in the receiver circuit may also be a microprocessor configured to perform functions similar to those described for the decoder/processor chip 902.

The terms a or an, as used herein, are defined as one or more than one. The term plurality, as used herein, is defined as two or more than two. The term another, as used herein, is defined as at least a second or more. The terms including and/or having, as used herein, are defined as comprising (i.e., open language). The term coupled, as used herein, is defined as connected, although not necessarily directly, and not necessarily mechanically. The term substantially, as used herein, is defined as at least approaching a given state (e.g., preferably within 10% of, more preferably within 1% of, and most preferably within 0.1% of).

The appended claims are not to be interpreted as including means-plus-function limitations, unless such a limitation is explicitly recited in a given claim using the phrase(s) “means for” and/or “step for.” Subgeneric embodiments of the invention are delineated by the appended independent claims and their equivalents. Specific embodiments of the invention are differentiated by the appended dependent claims and their equivalents.

What is claimed is:

1. An apparatus, comprising:
an animal trap;
a wireless radio frequency transmitter coupled to the animal trap, the wireless radio frequency transmitter transmitting a series of signals at substantially random intervals upon activation of the animal trap; and
a receiver configured to receive the series of signals from the wireless radio frequency transmitter.

2. The apparatus of claim 1, the wireless radio frequency transmitter comprising an outer housing, a transmit circuit, an antenna, and a power source.

3. The apparatus of claim 2, the transmit circuit comprising a timer circuit, an encoder/processor circuit controlled by the timer circuit, and a transmitter circuit.

4. The apparatus of claim 1, the animal trap comprising a live animal trap.

5. The apparatus of claim 4, the wireless radio frequency transmitter including a trap activation a sensor.

6. The apparatus of claim 5, the trap activation sensor comprising a disturbance switch.

7. The apparatus of claim 5, the trap activation sensor comprising a tilt switch.

8. The apparatus of claim 5, the trap activation sensor comprising a proximity sensor.

9. The apparatus of claim 5, the trap activation sensor comprising a magnetic switch.

10. The apparatus of claim 5, wherein the wireless radio frequency transmitter is mounted on a door or frame of the live animal trap.

11. The apparatus of claim 7, the trap activation sensor operating to supply power to a timer circuit within the wireless radio frequency transmitter enabling the wireless radio frequency transmitter to begin transmission of the series of signals.

12. The apparatus of claim 1, the animal trap comprising a spring-loaded rodent/animal trap.

13. The apparatus of claim 12, the wireless radio frequency transmitter being coupled to the animal trap by electrical contacts.

14. The apparatus of claim 13, wherein activation of the spring-loaded rodent/animal trap activates a timer circuit in the wireless radio frequency transmitter enabling the wireless radio frequency transmitter to transmit the series of signals.

15. The apparatus of claim 1, further comprising a plurality of transmitters.

16. The apparatus of claim 1, the receiver comprising:
an antenna a to receive the series of signals;
signal receiver circuit coupled to the antenna;
a decoder/processor circuit coupled to the signal receiver circuit;
an alert mechanism; and
a power source.

17. A wireless animal trap detection kit capable of being assembled in the field on a cage of a live animal trap, the kit comprising the combination of:
a wireless transmitter configured to be mounted on a live animal trap and to transmit at least one signal upon activation of the live animal trap;
a mounting mechanism adapted to affix the wireless transmitter to the live animal trap; and
a receiver locatable at a remote distance from the wireless transmitter and configured to receive the at least one signal and to alert a user of activation of the live animal trap.

18. The kit of claim 17, the mounting mechanism comprising a hook and loop fastener.

19. The kit of claim 17, the mounting mechanism comprising a clip.

20. The kit of claim 17, the mounting mechanism comprising a clamp.

21. The kit of claim 17, the mounting mechanism comprising a cable tie.

22. The kit of claim 17, the at least one signal comprising a series of signals transmitted at substantially random intervals.

23. A wireless animal trap detection kit capable of being assembled in the field to be electrically coupled to a spring-loaded rodent/animal trap, the kit comprising the combination of:
a wireless transmitter configured to be electrically coupled to a spring-loaded rodent/animal trap to form a closed circuit such that activation of the spring-loaded rodent/animal trap opens the circuit and to transmit at least one signal upon activation of the spring-loaded rodent/animal trap;
a connector adapted to electrically couple the wireless transmitter to the spring-loaded rodent/animal trap; and
a receiver locatable at a remote distance from the wireless transmitter and configured to receive the at least one signal from the wireless transmitter and to alert a user of activation of the spring-loaded rodent/animal trap.

24. The kit of claim 23, the at least one signal comprising a series of signals transmitted at substantially random intervals.
